(19) United States
(12) Patent Application Publication
(10) Pub. No.: US 2026/0066433 A1
(43) Pub. Date: Mar. 5, 2026

(54) BATTERY ARRAY HOUSING DESIGNS

(71) Applicant: FORD GLOBAL TECHNOLOGIES, LLC, Dearborn, MI (US)

(72) Inventors: Jie Deng, Novi, MI (US); Liam E. West, Ferndale, MI (US); David John Hill, Ann Arbor, MI (US); Pradeep Elumalai, Northville, MI (US)

(21) Appl. No.: 18/816,701

(22) Filed: Aug. 27, 2024

(51) Int. Cl. H01M 50/262; H01M 10/613; H01M 10/625; H01M 10/6568; H01M 10/658; H01M 50/211; H01M 50/242; H01M 50/249; H01M 50/271

(52) U.S. Cl. CPC H01M 50/262; H01M 10/613; H01M 10/625; H01M 10/6568; H01M 10/658; H01M 50/211; H01M 50/242; H01M 50/249; H01M 50/271; H01M 2220/20

(57) ABSTRACT

Array housing designs are disclosed for battery arrays of a traction battery pack. An exemplary battery array may include an array housing having a ribbed structure that includes at least one rib (e.g., external and/or internal) configured for increasing the structural stiffness of the battery array. A groove may extend at least partially through the rib, and an adhesive/sealant may be disposed within the groove for securing a surrounding structure relative to the array housing and thereby structurally integrating the battery array. In some implementations, the groove may receive a fin of a thermal barrier assembly of a battery cell stack of the battery array.

### TECHNICAL FIELD

This disclosure relates generally to electrified vehicle traction battery packs, and more particularly to array housing designs for providing structurally integrated battery arrays.

### BACKGROUND

An electrified vehicle includes a traction battery pack for powering electric machines and other electrical loads of the vehicle. The traction battery pack includes a plurality of battery cells and various other battery internal components that support electric vehicle propulsion.

### SUMMARY

A battery array for a traction battery pack according to an exemplary aspect of the present disclosure includes, among other things, an array housing including a rib, and a cell stack housed inside the array housing and including a first grouping of battery cells, a second grouping of battery cells, and a thermal barrier assembly arranged between the first grouping of battery cells and the second grouping of battery cells. A groove extends at least partially through the rib. A fin of the thermal barrier assembly is received within the groove, and an adhesive/sealant secures the fin within the groove.

In a further non-limiting embodiment of the foregoing battery array, the rib is an external rib.

In a further non-limiting embodiment of either of the foregoing battery arrays, the rib is an internal rib.

In a further non-limiting embodiment of any of the foregoing battery arrays, the rib is part of a top cover of the array housing.

In a further non-limiting embodiment of any of the foregoing battery arrays, the rib is part of a bottom cover of the array housing.

In a further non-limiting embodiment of any of the foregoing battery arrays, the rib is part of a top cover of the array housing, and a second rib is part of a bottom cover of the array housing.

In a further non-limiting embodiment of any of the foregoing battery arrays, a second groove extends at least partially through the second rib, a second fin of the thermal barrier assembly is received within the second groove, and a second adhesive/sealant secures the second fin within the second groove.

In a further non-limiting embodiment of any of the foregoing battery arrays, the rib is an external rib, and an internal rib is axially aligned with the external rib.

In a further non-limiting embodiment of any of the foregoing battery arrays, the groove extends through the internal rib and at least partially into the external rib.

In a further non-limiting embodiment of any of the foregoing battery arrays, the groove is axially aligned with the internal rib and the external rib.

In a further non-limiting embodiment of any of the foregoing battery arrays, the thermal barrier assembly separates a first compartment where the first grouping of battery cells resides from a second compartment where the second grouping of battery cells resides.

In a further non-limiting embodiment of any of the foregoing battery arrays, the first compartment and the second compartment each establishes a coolant flow passage inside the battery array.

In a further non-limiting embodiment of any of the foregoing battery arrays, the thermal barrier assembly is a multi-layered structure that includes the fin and at least one of a thermal resistance material layer or a foam layer.

In a further non-limiting embodiment of any of the foregoing battery arrays, an upper portion or a lower portion of the fin extends above or below the first grouping of battery cells or the second grouping of battery cells and is accommodated within the groove.

In a further non-limiting embodiment of any of the foregoing battery arrays, the array housing includes a second rib, and the cell stack includes a second thermal barrier assembly arranged between the second grouping of battery cells and a third grouping of battery cells. The battery array further includes a second groove extending at least partially through the second rib, a second fin of the second thermal barrier assembly is received within the second groove, and a second adhesive/sealant secures the second fin within the second groove.

A battery array for a traction battery pack according to another exemplary aspect of the present disclosure includes, among other things, an array housing including a first cover having an external rib and an internal rib, and a cell stack is housed inside the array housing and including a thermal barrier assembly arranged between a first battery cell and a second battery cell. A groove extends into the internal rib and in a direction toward the external rib. A fin of the thermal barrier assembly is received within the groove, and an adhesive/sealant secures the fin within the groove.

In a further non-limiting embodiment of the foregoing battery array, the first cover is a top cover.

In a further non-limiting embodiment of any of the foregoing battery arrays, the first cover is a bottom cover.

In a further non-limiting embodiment of any of the foregoing battery arrays, the groove extends at least partially into the external rib.

In a further non-limiting embodiment of any of the foregoing battery arrays, the adhesive/sealant surrounds at least three sides of the fin.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is a perspective view of an exemplary battery array of a traction battery pack.

FIG. 3 is an exploded view of the battery array of FIG. 2.

FIG. 4 is a cross-sectional view through section 4-4 of FIG. 2.

FIG. 5 is a blown-up view of a select portion of the battery array shown in FIG. 4.

FIG. 6 is a blown-up view of another select portion of the battery array shown in FIG. 4.

FIG. 7 illustrates a portion of an exemplary array housing.

FIG. 8 illustrates a portion of another exemplary array housing.

FIG. 9 illustrates a portion of yet another exemplary array housing.

FIG. 10 illustrates an interface between an array housing and a thermal barrier assembly of an exemplary battery array.

FIG. 11 illustrates an interface between an array housing and a thermal barrier assembly of another exemplary battery array.

FIG. 12 illustrates an interface between an array housing and a thermal barrier assembly of another exemplary battery array.

FIG. 13 illustrates an interface between an array housing and a thermal barrier assembly of yet another exemplary battery array.

### DETAILED DESCRIPTION

This disclosure details array housing designs for battery arrays of a traction battery pack. An exemplary battery array may include an array housing having a ribbed structure that includes at least one rib (e.g., external and/or internal) configured for increasing the structural stiffness of the battery array. A groove may extend at least partially through the rib, and an adhesive/sealant may be disposed within the groove for securing a surrounding structure relative to the array housing and thereby structurally integrating the battery array. In some implementations, the groove may receive a fin of a thermal barrier assembly of a battery cell stack of the battery array. These and other features are discussed in greater detail in the following paragraphs of this detailed description.

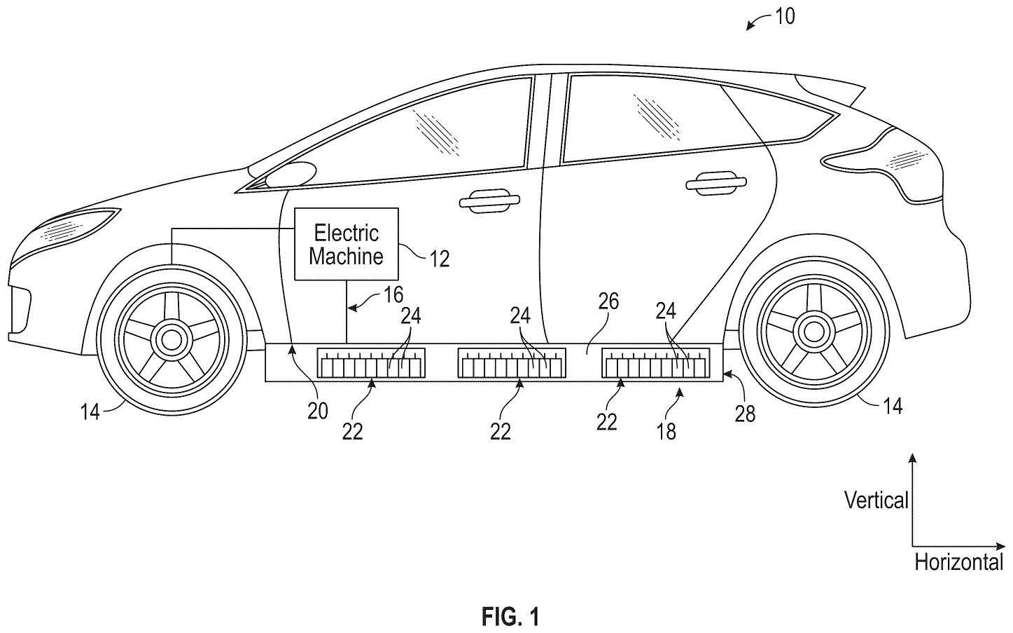

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

The traction battery pack 18 may include one or more battery arrays 22 (e.g., battery modules, assemblies, or groupings of rechargeable battery cells 24) capable of outputting electrical power to power the electric machine 12 and/or other electrical loads of the electrified vehicle 10. The one or more battery arrays 22 of the traction battery pack 18 may each include a plurality of battery cells 24 that store energy for powering various electrical loads of the electrified vehicle 10. The traction battery pack 18 could employ any number of battery arrays 22 and battery cells 24 within the scope of this disclosure. Accordingly, this disclosure should not be limited to the highly schematic configuration shown in FIG. 1.

In an embodiment, the battery cells 24 of each battery array 22 are lithium-ion pouch cells. However, battery cells having other geometries (cylindrical, prismatic, etc.), other chemistries (nickel-metal hydride, lead-acid, etc.), or both could alternatively be utilized within the scope of this disclosure.

The battery arrays 22 and various other battery internal components (e.g., bussed electrical center, battery electric control module, wiring, connectors, etc.) may be housed within an interior area 26 of an enclosure assembly 28. The enclosure assembly 28 may include an enclosure cover and an enclosure tray, for example. The enclosure cover may be secured (e.g., bolted, welded, adhered, etc.) to the enclosure tray to provide the interior area 26. The size, shape, and overall configuration of the enclosure assembly 28 is not intended to limit this disclosure.

FIGS. 2-6 illustrate features associated with a battery array 22 for a traction battery pack. For example, the traction battery pack 18 of the electrified vehicle 10 of FIG. 1 could include one or more battery arrays having a design substantially similar to that of the battery array 22 shown in FIGS. 2-6.

The battery array 22 may include one or more cell stacks 30 housed within an array housing 32. The array housing 32 may include a top cover 34 and a bottom cover 36, which may both exhibit tray-like structures. The top cover 34 may be positioned vertically above the bottom cover 36. Various terms such as “above,” “below,” “top,” and “bottom” are used relative to the arrangement of the components of the traction battery pack 18 in the various drawings and should not otherwise be deemed limiting. These terms are with reference to the general orientation of the traction battery pack 18 when installed on the electrified vehicle 10 of FIG. 1. Vertical, for purposes of this disclosure, is also with reference to ground and how the traction battery pack 18 is oriented when installed on the electrified vehicle 10.

The top cover 34 may be secured (e.g., bolted, welded, adhered, etc.) to the bottom cover 36 to provide a sealed enclosure for housing the cell stack 30. The size, shape, and configuration of the array housing 32 may vary within the scope of this disclosure.

The cell stack 30 may include a plurality of individual battery cells 24 arranged longitudinally between opposing end plates 38. The battery cells 24 may be arranged together along a cell stack axis A between the opposing end plates 38. Although a single cell stack 30 having a specific number of battery cells 24 is illustrated in the figures of this disclosure, the battery array 22 could include any number of cell stacks 30, with each cell stack 30 having any number of individual battery cells 24.

Thermal energy levels of the battery cells 24 of the battery array 22 can increase as the electrified vehicle 10 is operated. A thermal management system can be employed for managing the thermal energy levels of the battery cells 24 of the battery array 22. The thermal management system may be configured to route a coolant C through the battery array 22 in order to manage the thermal energy within the battery array 22 by, for example, using the coolant C to take on heat from the battery cells 24 of the cell stack 30.

In an embodiment, the thermal management system is an immersion thermal management system in which portions of the cell stack 30, here at least portions of the battery cells 24, for example, can be immersed in the coolant C. Thermal energy can transfer between the coolant C and the battery cells 24 as the coolant C flows over and/or around the battery cells 24 inside the array housing 32. The coolant C can help manage thermal energy levels of the battery cells 24 as well as other components of the battery array 22.

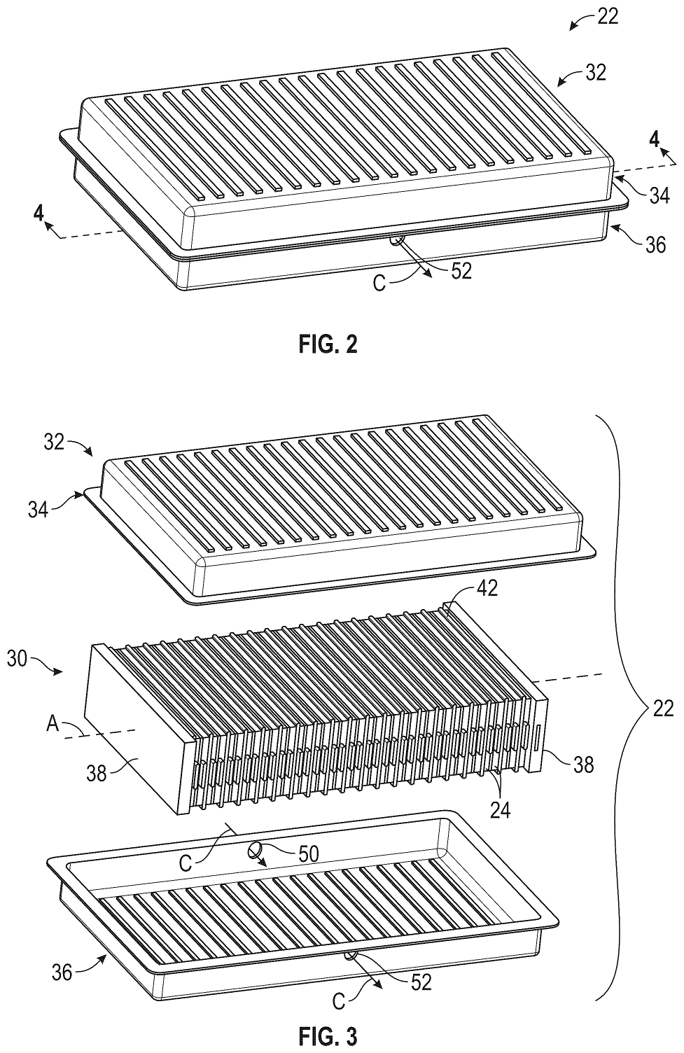

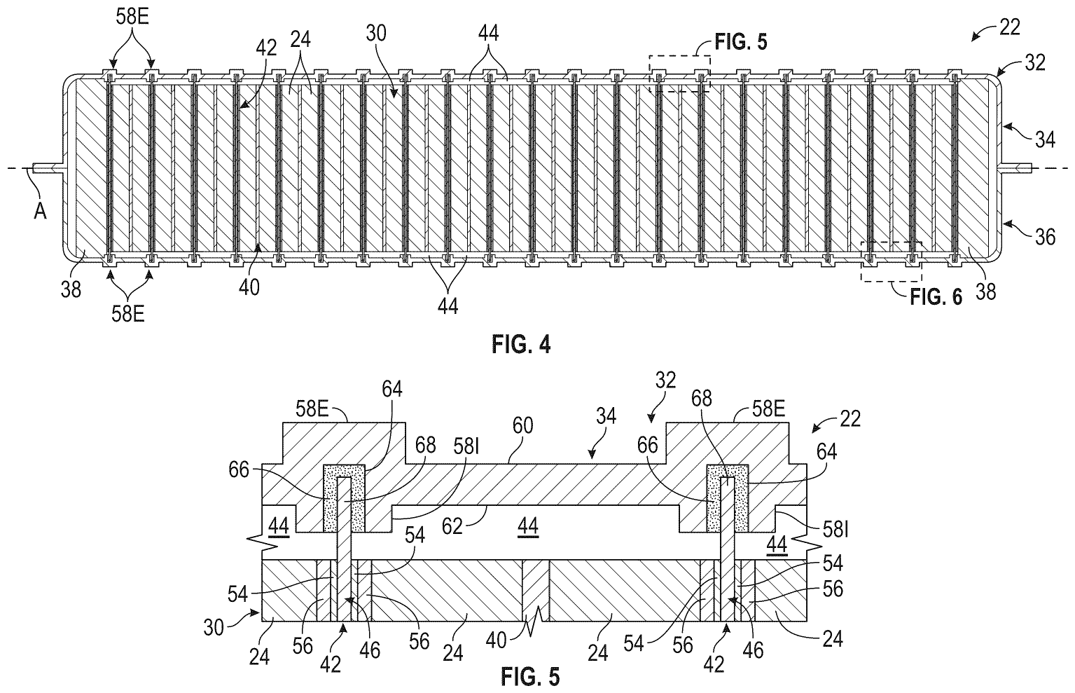

The thermal management system can deliver the coolant C to the interior area of the battery array 22 through an inlet 50 (see FIG. 3) of the array housing 32. The coolant C can fill one or more open areas (e.g., see compartments 44 in FIGS. 4-6) inside the battery array 22 such that the battery cells 24 are immersed in, and directly contacted by, the coolant C. The coolant C can take on thermal energy from the battery cells 24 for managing the thermal energy levels. The coolant C may exit the battery array 22 through an outlet 52 (see FIGS. 2-3) of the array housing 32. In an embodiment, both the inlet 50 and the outlet 52 are formed through the bottom cover 36 of the array housing 32. However, other inlet 50 and/or outlet 52 locations are contemplated within the scope of this disclosure.

The coolant C exiting through the outlet 52 can move to a thermal energy exchange device (not shown), such as a heat exchanger, where thermal energy can be transferred from the coolant C to atmosphere. A pump (not shown) can be operated to selectively circulate the coolant C between the battery array 22 and the thermal energy exchange device and then back to the battery array 22 as part of a closed-loop system.

The coolant C circulated in the immersion thermal management system may be a dielectric fluid or another type of non-electrically conductive fluid (e.g., oil) that is designed for immersion cooling the battery cells 24. However, other non-conductive fluids may also be suitable, and the actual chemical make-up and design characteristics (e.g., dielectric constant, maximum breakdown strength, boiling point, thermal conductivity, etc.) may vary depending on the environment the battery array 22 is to be deployed.

In another embodiment, the thermal management system is a conventional cold plate system in which the coolant C, such as ethylene glycol, is circulated through a cold plate (not shown) in order to thermally manage heat generated by the battery cells 24. The teachings of this disclosure are therefore not limited to battery arrays having immersion thermal management systems. In some embodiments, the battery cells 24 are not immersed in the coolant C in the cold plate type of thermal management system.

A cell expansion pad 40 (best shown in FIGS. 4-6) may be arranged between neighboring battery cells 24 within the cell stack 30. The cell expansion pads 40 may include a material(s) (e.g., polyurethane foam, silicone foam, etc.) adapted for accommodating battery cell swelling.

Referring now primarily to FIGS. 4-6, with continued reference to FIGS. 2-3, one or more thermal barrier assemblies 42 may be arranged along the respective cell stack axis A of the cell stack 30. The thermal barrier assemblies 42 may compartmentalize the cell stack 30 into two or more groupings or compartments 44. Each thermal barrier assembly 42 may function to inhibit the transfer of thermal energy from compartment 44 to its neighboring compartment 44 across the cell stack 30.

Each compartment 44 may hold one or more of the battery cells 24 of the cell stack 30. The compartments 44 may additionally establish dedicated coolant flow passages for directing the coolant C through the battery array 22 as part of the immersion thermal management system described above.

In an embodiment, groups of two individual battery cells 24 are separated by thermal barrier assemblies 42 along the cell stack axis A of the cell stack 30. However, other configurations are contemplated within the scope of this disclosure, and it should be evident to those having the benefit of this disclosure that the cell stack 30 could include any number of and any arrangement of battery cells 24, cell expansion pads 40, and thermal barrier assemblies 42.

Each thermal barrier assembly 42 may include a fin 46 that is flanked by additional layers, such as foam and/or thermal resistance material layers, for example, as part of a multi-layered structure of the thermal barrier assembly 42. In an embodiment, the fin 46 is sandwiched between a pair of thermal resistance material layers 54, and a pair of foam layers 56 may be positioned outboard of the thermal resistance material layers 54. The foam layers 56 may thus flank the thermal resistance material layers 54 and can be positioned in abutting contact with major side surfaces of battery cells 24 located in adjacent compartments 44 of the cell stack 30.

The fin 46 may be a metallic structure of the thermal barrier assembly 42. In an embodiment, the fin 46 is made of stainless steel. In another embodiment, the fin 46 is made of aluminum. However, other materials, including but not limited to high temperature resistance thermoplastic and thermoset composites, could be utilized to construct each fin 46 within the scope of this disclosure.

The thermal resistance material layers 54 may include aerogel layers or mica sheets, for example, and the foam layers 56 may include polyurethane foam or silicone foam, for example. However, other materials or combinations of materials could be utilized to construct the sublayer components of each thermal barrier assembly 42 within the scope of this disclosure.

Portions of the array housing 32 may be ribbed for increasing its structural stiffness and reducing displacement during shock and vibration. For example, the top cover 34, the bottom cover 36, or both may include a plurality of ribs 58 for increasing the structural stiffness of the array housing 32. The ribs 58 increase the thickness at certain locations of the top cover 34 and/or bottom cover 36 of the array housing 32.

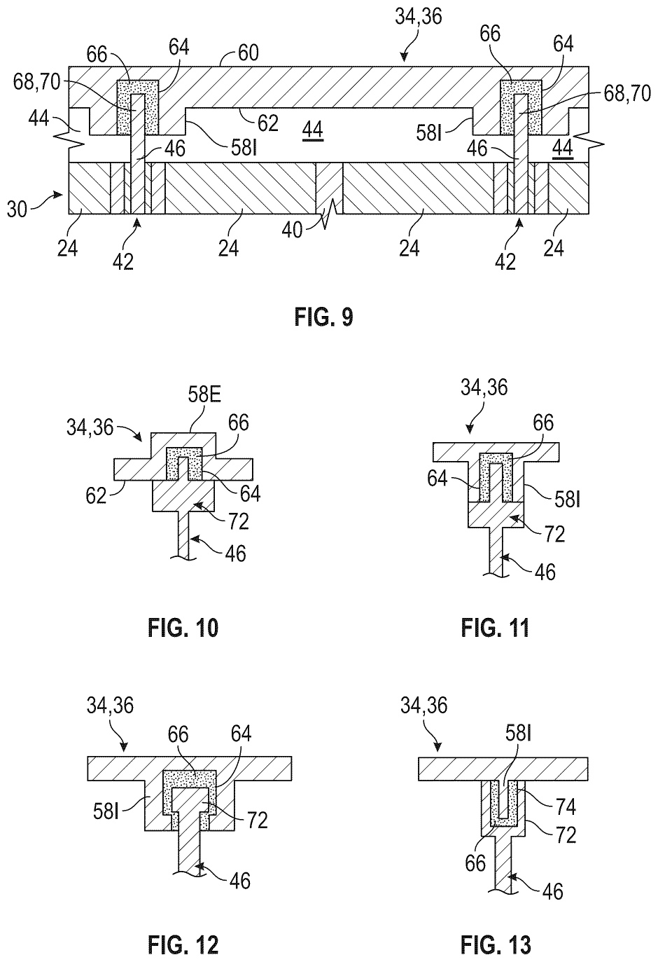

In an embodiment, the top cover 34 and/or the bottom cover 36 includes both external ribs 58E and internal ribs 58I (see, e.g., the embodiment of FIGS. 4-7). The external ribs 58E may protrude outwardly from an outer wall 60 of the top cover 34 or the bottom cover 36, and the internal ribs 58I may protrude inwardly from an inner wall 62 of the top cover 34 or bottom cover 36. In another embodiment, the top cover 34 and/or the bottom cover 36 includes only the external ribs 58E (see, e.g., FIG. 8). In yet another embodiment, the top cover 34 and/or the bottom cover 36 includes only the internal ribs 58I (see, e.g., FIG. 9). The total number, location, and arrangement of the ribs 58 may depend on the structural stiffness requirements of the battery array 22, among other factors. This disclosure is therefore not intended to be limited to the specific designs shown in the various figures, and it should be appreciated that slight modification could fall within the scope of this disclosure.

The top cover 34 and/or the bottom cover 36 may additionally include a plurality of grooves 64. The grooves 64 may be formed in the top cover 34 and/or the bottom cover 36 at the same location of the increased thickness provided by the ribs 58E and/or 58I. In implementations in which both the external ribs 58E and the internal ribs 58I are provided (see, e.g., FIGS. 5-7), each groove 64 may extend through one of the internal ribs 58I and may extend at least partially into the external rib 58E that is axially aligned with the internal rib 58I. In implementations in which only the external ribs 58E are provided (see, e.g., FIG. 8), each groove 64 may extend through the inner wall 62 and at least partially into one of the external ribs 58E. In implementations in which only the internal ribs 58I are provided (see, e.g., FIG. 9), each groove 64 may extend through one of the internal ribs 58I in a direction toward the outer wall 60.

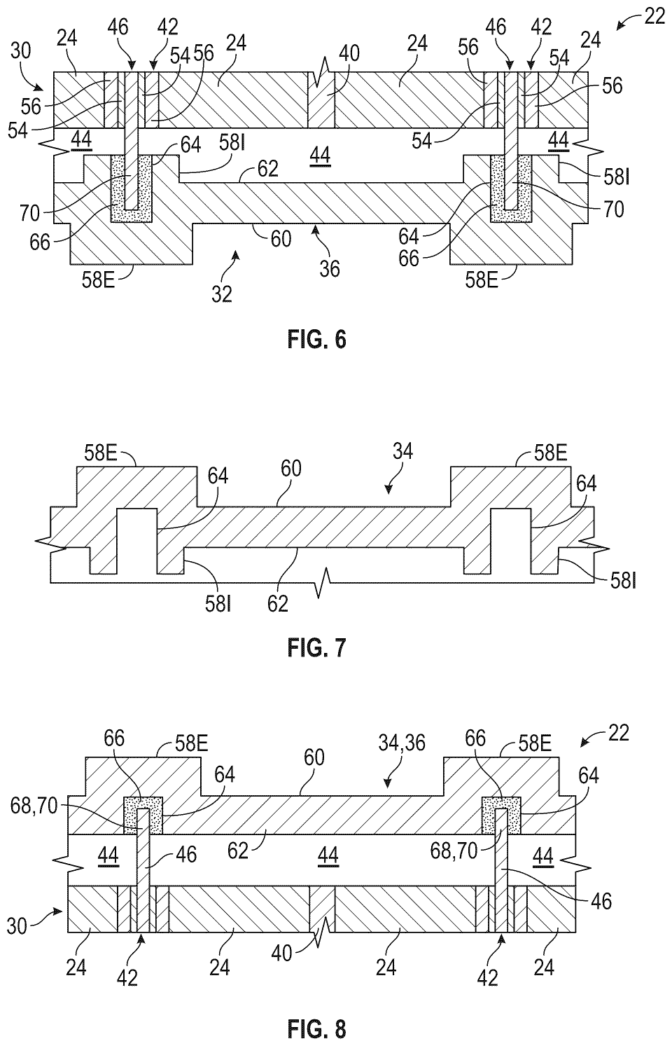

Each groove 64 may provide an open space in the array housing 32 for accommodating the fin 46 of one of the thermal barrier assemblies 42 of the cell stack 30. For example, an upper portion 68 or a lower portion 70 of each fin 46 may be accommodated within each respective groove 64. The upper portions 68 extend above the battery cells 24 of the cell stack 30 (see, e.g., FIG. 5), and the lower portions 70 extend below the battery cells 24 of the cell stack 30 (see, e.g., FIG. 6). Each of the upper portion 68 and the lower portion 70 may include a plane shape. In an embodiment, the plane shape is rectangular. The plane shapes of the upper portion 68/lower portion 70 provide smaller peak stresses than non-plane shapes and thus, when used in combination with the grooves 64, enable increased structural and thermal performance without reducing packaging efficiency.

The locations and sizes (e.g., width and depth) of the ribs 58 and the grooves 64 may depend on factors such as the clearance distances between the array housing 32 and the battery cells 24, structural and thermal performance requirements of the battery array 22, assembly and manufacturing feasibility of the battery array 22, etc.

An adhesive/sealant 66 may be disposed within each groove 64 for structurally joining the fins 46 to the array housing 32 and thereby increasing the structural integrity of the battery array 22. The adhesive/sealant 66 may be an epoxy based adhesive or a urethane based adhesive, for example. By joining the fins 46 to the array housing 32 via the grooves 64 and adhesive/sealant 66, the contact area between the array housing 32 and the fins 46 is increased, thereby reducing bulking of the fins 46 and increasing heat transfer between the array housing 32 and the thermal barrier assemblies 42. Moreover, the adhesive/sealant 66 functions to seal the compartments 44 from one another, thereby establishing dedicated coolant flow passages inside the battery array 22 for achieving immersion cooling.

Due at least in part to the plane shape of the upper portion 68/lower portion 70 of the fins 46, the adhesive/sealant 66 may contact each fin 46 along three faces (e.g., opposing sides and either top or bottom). The adhesive/sealant 66 will thus mainly carry shear forces (e.g., those acting in the vertical or Z-axis direction) as opposed to peel forces (e.g., those acting in the horizontal or X-axis direction), which may preserve the integrity of the adhesion during shock and vibration.

Referring now to FIGS. 10-11, the fin 46 of each thermal barrier assembly 42 may in some implementations incorporate a shoulder 72 that is configured to establish a flat interface and locator relative to the inner wall 62 (see FIG. 10) or the internal rib 58I (see FIG. 11) of the top cover 34 or bottom cover 36 of the array housing 32. In other implementations, the shoulder 72 may be configured to interlock with the groove 64 (see, e.g., FIG. 12). In still other implementations, the shoulder 72 may provide a separate groove 74 for receiving the internal rib 58I of the top cover 34 or the bottom cover 36 (see, e.g., FIG. 13).

The exemplary battery arrays of this disclosure include array housings having a combination of rib and groove features that facilitate interfacing connections between the array housing and thermal barrier assemblies of a cell stack of the battery array. The proposed designs increase structural stiffness and integrity, heat transfer, and packaging efficiency, and facilitate the use of immersion cooling for thermally managing the battery array.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A battery array for a traction battery pack, comprising:
an array housing including a rib;
a cell stack housed inside the array housing and including a first grouping of battery cells, a second grouping of battery cells, and a thermal barrier assembly arranged between the first grouping of battery cells and the second grouping of battery cells;
a groove extending at least partially through the rib;
a fin of the thermal barrier assembly received within the groove; and
an adhesive/sealant that secures the fin within the groove.

2. The battery array as recited in claim 1, wherein the rib is an external rib.

3. The battery array as recited in claim 1, wherein the rib is an internal rib.

4. The battery array as recited in claim 1, wherein the rib is part of a top cover of the array housing.

5. The battery array as recited in claim 1, wherein the rib is part of a bottom cover of the array housing.

6. The battery array as recited in claim 1, wherein the rib is part of a top cover of the array housing, and further comprising a second rib that is part of a bottom cover of the array housing.

7. The battery array as recited in claim 6, comprising:
a second groove extending at least partially through the second rib;
a second fin of the thermal barrier assembly received within the second groove; and
a second adhesive/sealant that secures the second fin within the second groove.

8. The battery array as recited in claim 1, wherein the rib is an external rib, and comprising an internal rib that is axially aligned with the external rib.

9. The battery array as recited in claim 8, wherein the groove extends through the internal rib and at least partially into the external rib.

10. The battery array as recited in claim 9, wherein the groove is axially aligned with the internal rib and the external rib.

11. The battery array as recited in claim 1, wherein the thermal barrier assembly separates a first compartment where the first grouping of battery cells resides from a second compartment where the second grouping of battery cells resides.

12. The battery array as recited in claim 11, wherein the first compartment and the second compartment each establishes a coolant flow passage inside the battery array.

13. The battery array as recited in claim 1, wherein the thermal barrier assembly is a multi-layered structure that includes the fin and at least one of a thermal resistance material layer or a foam layer.

14. The battery array as recited in claim 13, wherein an upper portion or a lower portion of the fin extends above or below the first grouping of battery cells or the second grouping of battery cells and is accommodated within the groove.

15. The battery array as recited in claim 1, wherein the array housing includes a second rib and the cell stack includes a second thermal barrier assembly arranged between the second grouping of battery cells and a third grouping of battery cells, and the battery array further comprises:
a second groove extending at least partially through the second rib;
a second fin of the second thermal barrier assembly received within the second groove; and
a second adhesive/sealant that secures the second fin within the second groove.

16. A battery array for a traction battery pack, comprising:
an array housing including a first cover having an external rib and an internal rib;
a cell stack housed inside the array housing and including a thermal barrier assembly arranged between a first battery cell and a second battery cell;
a groove extending into the internal rib and in a direction toward the external rib;
a fin of the thermal barrier assembly received within the groove; and
an adhesive/sealant that secures the fin within the groove.

17. The battery array as recited in claim 16, wherein the first cover is a top cover.

18. The battery array as recited in claim 16, wherein the first cover is a bottom cover.

19. The battery array as recited in claim 16, wherein the groove extends at least partially into the external rib.

20. The battery array as recited in claim 16, wherein the adhesive/sealant surrounds at least three sides of the fin.
